(19) United States
(12) Patent Application Publication
(10) Pub. No.: US 2026/0126412 A1
(43) Pub. Date: May 7, 2026

(54) Gas Ion Distillation

(71) Applicants: University of Helsinki, University of Helsinki (FI); Airsense Analytics GmbH, Schwerin (DE); Karsa Oy, Helsinki (FI); T4i Engineering Private Company, Ilioupoli (GR)

(72) Inventors: Gary EICEMAN, Las Cruces, NM (US); Elie LATTOUF; Osmo ANTTALAINEN, Helsinki (FI); Paula VANNINEN, Helsinki (FI); Hanna HAKULINEN, Helsinki (FI); Andreas WALTE; Bert UNGETHUEM; Oliver HECHT; Stefan ZIMMERMANN; Ansgar KIRK; Alexander BOHNHORST; Anne ZYGMANOWSKI; Maximilian KÜDDELSMANN; Jyri MIKKILÄ, Helsinki (FI); George PALLIS; George PSARRAS

(21) Appl. No.: 19/492,165

(22) PCT Filed: Jun. 10, 2024
(86) PCT No.: PCT/FI2024/050301

§ 371 Date: Dec. 11, 2025

(30) Foreign Application Priority Data
Jun. 13, 2023 (FI) 20235661

(51) Int. Cl. G01N 27/622; B01D 53/32; H01J 49/04

(52) U.S. Cl. CPC G01N 27/622; B01D 53/323; H01J 49/0422

(57) ABSTRACT

A method of separating chemical constituents by gas ion distillation, comprising introducing a gaseous sample into a reaction space at a pressure above about 10 torr, wherein the gaseous sample comprises at least two chemical constituents; introducing a gaseous reactant into the reaction space, wherein the reactant comprises reactant ions configured to selectively ionize the at least two chemical constituents of the sample; allowing the reactant ions to selectively ionize the at least two chemical constituents of the sample to form product ions, wherein the order of product ion formation is governed by the vapour concentrations of the at least two chemical constituents, the concentration of the reactant ions and the reaction rate coefficients of the at least two chemical constituents; and subsequently removing the ionized at least two constituents from the reaction space in the order of product ion formation.

### TECHNICAL FIELD

The present disclosure generally relates to separation of chemical constituents in a chemical mixture. In particular, but not exclusively, the present disclosure relates to separation of chemical constituents in a chemical mixture in gaseous phase. In particular, but not exclusively, the present disclosure relates to separation of chemical constituents of a chemical mixture in gaseous phase at ambient pressure.

### BACKGROUND

This section illustrates useful background information without admission of any technique described herein representative of the state of the art.

Chemical mixtures are found today with nearly every item, whether of natural or synthetic origin, such as detergents, fuels, coatings, cosmetics, pharmaceuticals, and others, i.e., mixtures formulated to provide certain desirable physical and/or chemical properties. Examples of mixtures in the natural world are found in environmental systems and even in the products of human metabolic processes—e.g., breath, sweat—with tens to hundreds of volatile organic compounds, VOC, in a single sample. Different mixtures of chemicals are used also in chemical industry. Furthermore, there are situations, such as industrial accidents where various mixtures are inadvertently released sometimes in excessive amounts into our environment and might cause dangerous situations to first responders and others. Currently, technical challenges exist in determining the chemical identity of substances in ambient atmospheres with complex, or even simple, mixtures using chemical analyzers.

A technical challenge in determining the chemical composition of a chemical mixture is the need for pre-separation of constituents since modern physical methods of analysis lack inherent selectivity to identify specific substances especially within a mixture or matrix. Chromatographic methods (or solvent extraction and conventional distillation) have been historic solutions to separating mixtures or matrix interferences. Although widely practiced, such methods contain practical and economical limitations, such as high material and energy costs, demand for solvents and their waste disposal, and prolonged separation times.

Accordingly, there is a need for a separation technology that is fast, reliable and cost-effective. Furthermore, the technology should enable live measurements and be compatible with detectors such as mass spectrometers and ion mobility spectrometers.

The inventors have found that using gas ion distillation that is based on chemical reactions instead of classic separation methods based on physical properties—such as solubility, vapour pressure and diffusion-based mass transport—mitigates the issues of the known technologies. Accordingly, it is the object of the present invention to mitigate the issues arising in separation and provide an improved separation of chemical constituents by gas ion distillation.

### SUMMARY

The appended claims define the scope of protection. Any examples and technical descriptions of apparatuses, products and/or methods in the description and/or drawings not covered by the claims are presented not as embodiments of the invention but as background art or examples useful for understanding the invention.

In an example aspect, there is provided a method of separating chemical constituents by gas ion distillation, comprising
introducing a gaseous sample into a reaction space at a pressure above about 10 torr, wherein the gaseous sample comprises at least two chemical constituents;
introducing a gaseous reactant into the reaction space, wherein the reactant comprises reactant ions configured to selectively ionize the at least two chemical constituents of the sample;
allowing the reactant ions to selectively ionize the at least two chemical constituents of the sample to form product ions, wherein the order of product ion formation is governed by the vapour concentrations of the at least two chemical constituents, the concentration of the reactant ions and the reaction rate coefficients of the at least two chemical constituents; and subsequently
removing the ionized at least two constituents from the reaction space in the order of product ion formation.

The reaction space may be at or near ambient pressure.

The method may further comprise providing a flow of neutral gas into the reaction space in order to retain the gaseous sample in the reaction space.

Removing the ionized at least two constituents from the reaction space may comprise conveying using electric fields.

The reactant ions may comprise ions selected from the group of hydrated protons H⁺(H₂O)ₙ, ammonia ions (H₂O)ₙNH₄⁺ and acetone ions such as (CH₃COCH₃)₂H⁺.

The ionization of a chemical constituent may be governed by the vapour concentration of the constituent, the concentration of the reactant ions, and the reaction rate coefficients k₁ and k₂ of the chemical constituent with the equation of

$$\frac{d [ {R}^{+} ]}{dt} = - {k}_{1} [ M ] [ {R}^{+} ] - {k}_{2} [ N ] [ {R}^{+} ] .$$

Removing the ionized at least two constituents from the reaction space may comprise conveying them to an analysis.

Removing the ionized at least two constituents from the reaction space may comprise temporarily trapping them into the reaction space.

The analysis may comprise an analysis with an ion mobility spectrometer, a mass spectrometer or a further spectroscopic or electrochemical analytical instrument.

Introducing a gaseous reactant comprising reactant ions into the reaction space may comprise introducing a gaseous reactant into the reactant space and generating the reactant ions therein.

The reactant ions may be generated by ionization using radioactive sources, non-radioactive sources such as electron sources, electrical discharge sources such as corona or barrier discharge, X-ray sources, UV sources and/or lasers.

According to a second example aspect, there is provided an apparatus for separating chemical constituents by gas ion distillation, comprising
a reaction space;
means for introducing a gaseous sample into the reaction space at a pressure above about 10 torr, wherein the gaseous sample comprises at least two chemical constituents;
means for introducing a gaseous reactant into the reaction space, wherein the reactant comprises reactant ions configured to selectively ionize the at least two chemical constituents of the sample;
means for removing the ionized at least two constituents from the reaction space in the order of product ion formation, wherein the at least two chemical constituents have been ionized in the reaction space by allowing the reactant ions to selectively ionize the at least two chemical constituents of the sample to form product ions, wherein the order of product ion formation is governed by the vapour concentrations of the at least two chemical constituents, the concentration of the reactant ions and the reaction rate coefficients of the at least two chemical constituents.

The reaction space may be at or near ambient pressure.

The apparatus may further comprise an analyzer, and an ion outlet for removing ions from the reaction space and configured to be attached to an analyzer.

The analyzer may comprise an ion mobility spectrometer or a mass spectrometer or a further spectroscopic or electrochemical analytical instrument.

The means for removing the ionized at least two constituents from the reaction space may comprise an arrangement for generating electric fields for transporting the ionized at least two constituents.

The means for removing the ionized at least two constituents from the reaction space may comprise an arrangement for generating electric fields temporarily trapping the ionized at least two constituents.

The means for removing the ionized at least two constituents from the reaction space may comprise an arrangement for removing the ionized at least two constituents temporally or spatially separated.

The apparatus may further comprise a cylindrical frame defining the reaction space therein, wherein the reaction space is cylindrical.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 shows an example separation result according to an embodiment of the invention;

FIG. 2 shows a flow chart of a method according to an example embodiment of the invention;

FIG. 3 shows an experimental separation result of a method according to an embodiment of the invention;

FIG. 4 shows an experimental result of a method according to an embodiment of the invention;

FIG. 5 shows a schematic view of an apparatus according to an example embodiment of the invention;

FIG. 6 shows a schematic three-dimensional sectional view of an apparatus according to an example embodiment of the invention;

FIG. 7 shows a schematic view of an apparatus according to an example embodiment of the invention;

FIG. 8 shows a schematic view of an apparatus according to an example embodiment of the invention;

FIG. 9 shows a schematic view of an apparatus according to an example embodiment of the invention;

FIG. 10 shows a schematic view of an apparatus according to an example embodiment of the invention;

FIG. 11 shows a schematic view of an apparatus according to an example embodiment of the invention; and

FIG. 12 shows a schematic view of an apparatus according to an example embodiment of the invention.

### DETAILED DESCRIPTION

In the following description, like reference signs denote like elements or steps.

The present invention provides for methods and instruments for separation of chemical constituents of a mixture using gas ion distillation, GID. In gas ion distillation prefractionation of a chemical mixture is based on the inherent selectivity of gas phase ion-molecule reactions to replace the classic methods for chemical separations using partition coefficients as found in gas and liquid chromatography. In an example embodiment of gas ion distillation according to the present invention, reactant ions, for example gaseous hydrated protons, are introduced into a vapour mixture where constituents undergo reactions based on displacement reactions as shown in the following equation as an example

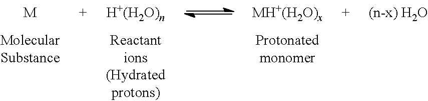

These binary reactions are governed by the vapour concentrations of the substance M, the concentration of reactant ions such as hydrated protons, and most significantly, the reaction rate coefficient k_{M} for individual constituents:

$$\frac{d [ {{MH}^{+} ( {H}_{2} O )}_{x} ]}{dt} = {k}_{M} \cdot [ M ] \cdot [ {{H}^{+} ( {H}_{2} O )}_{n} ]$$

In a further example embodiment of gas ion distillation according to the present invention, reactant ions are introduced into a vapour mixture where constituents undergo reactions based on displacement reactions as shown in the following equation for types of reactant ions discussed hereinafter.

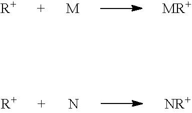

The rate of formation of product ions and consumption of sample neutrals and reagent ions are combined in the following system of differential equations:

$$\frac{d [ M {R}^{+} ]}{dt} = {k}_{1} [ M ] [ {R}^{+} ]$$

$$\frac{d [ N {R}^{+} ]}{dt} = {k}_{2} [ N ] [ {R}^{+} ]$$

$$\frac{d [ {R}^{+} ]}{dt} = - {k}_{1} [ M ] [ {R}^{+} ] - {k}_{2} [ N ] [ {R}^{+} ]$$

$$\frac{d [ M ]}{dt} = - {k}_{1} [ M ] [ {R}^{+} ]$$

$$\frac{d [ N ]}{dt} = - {k}_{2} [ N ] [ {R}^{+} ]$$

Where k₁ and k₂ are the individual rate coefficients for M and N respectively. These reactions are governed by the vapour concentrations of the substance [M], the concentration of reactant ions [R], and most significantly, the reaction rate coefficients k₁ and k₂.

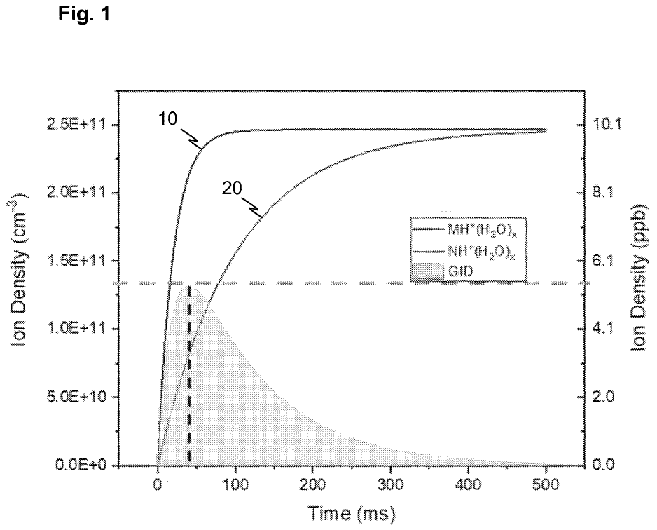

Models of GID with a binary mixture demonstrated that ion distillation could be observed as differences in the relative abundance of ions extracted in fields which apply forces to the ions, for example electric fields, of a GID structure. In an embodiment, the fields comprise for example electrostatic or electrodynamic fields This is shown in FIG. 1 where the separation of compounds M 10 N 20 as protonated monomers occurs with optimum efficiency of separation, shown as gray area, at about 40 ms. Instead of hydrated protons, other ions also such as so-called dopant ions can be used. The dopant ions could be formed for example from ammonia or acetone.

In the following, embodiments of the present invention are described in detail.

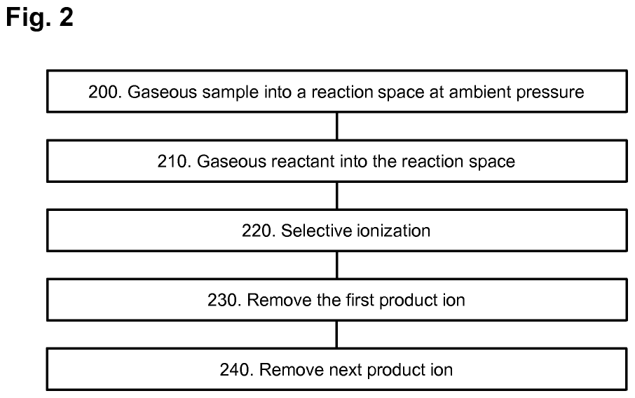

FIG. 2 shows a flow chart of a method according to an example embodiment. At step 200 a gaseous sample is introduced into a reaction space, in an embodiment at or near ambient pressure. In a further embodiment, the pressure is above about 10 torr, for example from 10 torr to 1000 torr, i.e. the reactions need not take place in a vacuum. In an embodiment, the sample comprises at least two chemical constituents, or analytes. Hereto it is noted that the following method steps also work for a sample having a single chemical constituent, i.e. the method is applicable also in view of handling a sample having a single analyte of interest. In an embodiment, the sample comprises a mixture of several unknown chemical constituents. In an embodiment, the sample comprises ambient air comprising unknown chemical constituents, such as volatile organic compounds. Example embodiments describing the introduction of the sample and the reaction space in more detail will be discussed hereinafter.

At step 210 a gaseous reactant is introduced into the reaction space. In an embodiment, the reactant comprises reactant ions configured to selectively ionize the chemical constituents of the sample. In an embodiment, the reactant ions are caused to be produced outside the reaction space and conducted into the reaction space thereafter. In a further embodiment, the gaseous reactant is introduced into the reaction space and subsequently the reactant ions are produced therein. In an embodiment, the reactant ions comprise hydrated protons, or H⁺(H₂O)ₙ. In a further embodiment, the reactant ions comprise for example ammonia ions (H₂O)ₙNH₄⁺ or acetone ions such as (CH₃COCH₃)₂H⁺. In a still further embodiments reactant ions comprise ions selected from the group of water, acetone, ammonia, dimethyl sulfoxide, chlorocarbons such as CHCl₃, CHBr₃, and CHI₃, nonyl amide, nonanone and methyl salicylate.

It is to be noted that all the steps described above can also occur with negative ions. Negative reactant ions are usually hydrated oxygen ions O₂⁻(H₂O)ₙ which will react with a molecular substance M to form a production ion MO₂⁻(H₂O)ₙ₋ₓ and water xH₂O. Alternative reactant ions for negative product ions are in an embodiment chloride or bromide ions.

At step 220 selective ionization takes place. The reactant ions are allowed to selectively ionize the chemical constituents of the sample thus forming product ions from each constituent. The order of product ion formation is governed by the vapour concentrations of the chemical constituents of the sample, the concentration of the reactant ions and the reaction rate coefficients of the chemical constituents of the sample. The reaction rate coefficients are compound specific and depend e.g. on temperature, type of reactant ion, pressure, moisture, and the supporting gas atmosphere. In an example embodiment, the conditions in which the method operates are as follows: Pressure from about 10 torr to 1000 torr, moisture of 0 to 100% r.H. in sample and temperature in the range of about 5 to 40° C. for the sample.

The selective ionization reaction takes place with the following example reaction chemistry shown for positive ions. The example of the reaction chemistry is for a binary mixture of two chemical constituents M and N using hydrated protons as reactant ions. The example does not include further reactions such as dimer formation or cross reactions. Brackets in the following equations denote concentrations or densities and k_{X} is corresponding to the reaction rate coefficient.

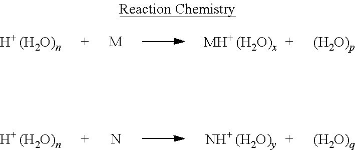

$$\begin{matrix}Product Ions \\ \begin{matrix}\frac{d [ M {{H}^{+} ( {H}_{2} O )}_{x} ]}{dt} = {k}_{M} \cdot [ {{H}^{+} ( {H}_{2} O )}_{n} ] \cdot [ M ] & \begin{matrix}\frac{d [ N {{H}^{+} ( {H}_{2} O )}_{y} ]}{dt} = {k}_{N} \cdot \\ [ {H}^{+} {( {H}_{2} O )}_{n} ] \cdot [ N ]\end{matrix}\end{matrix}\end{matrix}$$

$$\begin{matrix}Reactant Vapours \\ \begin{matrix}\frac{d [ M ]}{dt} = - {k}_{M} \cdot [ {{H}^{+} ( {H}_{2} O )}_{n} ] \cdot [ M ] & \frac{d [ N ]}{dt} = - {k}_{N} \cdot [ {{H}^{+} ( {H}_{2} O )}_{n} ] \cdot [ N ]\end{matrix}\end{matrix}$$

$$\begin{matrix}Reactant Ion \\ \frac{d [ {{H}^{+} ( {H}_{2} O )}_{n} ]}{dt} = - {k}_{M} \cdot [ {{H}^{+} ( {H}_{2} O )}_{n} ] \cdot [ M ] - {k}_{N} \cdot [ {{H}^{+} ( {H}_{2} O )}_{n} ] \cdot [ N ]\end{matrix}$$

At step 230 the first product ions are removed from the reaction space, i.e. the product ions of the chemical constituent that is ionized first by the reactant ions. At step 240 the next product ions are removed from the reaction space, i.e. the product ions of the chemical constituent that is ionized next by the reactant ions. Step 240 is repeated until all chemical constituents of the sample that are to be separated have been processed. In an embodiment, the ions are removed from the reaction space using electric fields. The details of ion removal from the reaction space will be discussed in more detail hereinafter.

In an example of the gas ion distillation method according to the invention the chemical reactions occur with a sample in the gas phase usually at or near ambient pressure. The reactions are also possible at under-pressures starting at around 10 Torr to overpressures of many bars. Such reactions are fast, i.e. ion collisions occur every 100 picoseconds and full conversion of chemical constituent M to MH+(H₂O)ₙ₋₁ will occur in about 0.01 to 100 milliseconds depending for example on the concentration of the chemical constituent M. Removal of ions from the gas-ion mixture is moderately fast with speeds of ion swarms at ambient pressure of about 10 m/s in electric fields of 30 V/mm. Any collisions of ions with surfaces result in neutralization and disruption of the ion separation process. Fortunately, ions can be constrained in electric fields with controlled radial diffusion smaller than 1 mm/ms. Thus, ions may be pre-fractionated in small structures of a few cm or smaller in less than 1 s, as the inventors have demonstrated with a proof-of-concept ion neutral separator. Chemical reactions between M and H⁺(H₂O)ₙ have no activation energy and are collision-based, following second order kinetics. Reaction times are governed by the substance specific reaction rate, reactant ion concentration and vapour concentration of the chemical constituent M and the reactions can be complete within microseconds for concentration of the chemical constituent M at ppm levels and within 0.1 to 10 ms for concentration of about 10 to 50 ppb. Ion formation is competitive and small differences in reaction selectivity of chemicals permit stepwise and sequential ionization, that is, a distillation by reaction chemistry.

In an example of the gas ion distillation method according to the invention with a mixture comprising amines, aldehydes, esters and aromatics, amine at 900 kJ/mol is the first chemical constituent ionized and removed from the sample. When amine vapours are depleted from the mixture, esters at 850 kJ/mol are ionized next from the remaining vapours and removed. Aldehydes at 800 kJ/mol are next, followed by aromatics. The process of re-ionization of the sample is repeated until no further reactions occur, e.g. no additional product ions are produced. The gas ion distillation method according to embodiments of the invention has been verified experimentally. Proof-of-concept measurements were made demonstrating the use of reaction selectivity in the gas phase separation of a binary mixture where ions derived from reactions discussed hereinbefore were extracted and mass analyzed continuously as a sample was washed with hydrated protons.

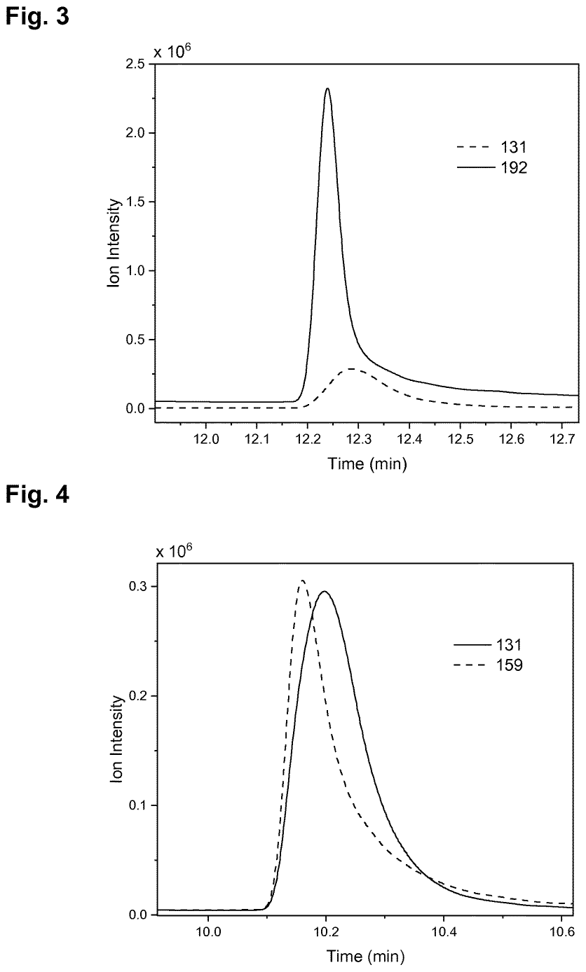

Results from the separation of a binary mixture are shown in FIGS. 3 and 4 for two combinations of equimolar binary mixtures at two extremes of reactivity. In the experiment of FIG. 3, differences in ionization properties were large with 2,6-di-t-butyl pyridine and pentyl acetate as the chemical constituents and the separation of mass significant with strong and fast ionization of the 2,6-di-t-butyl pyridine and with a significant lag in ionization of pentyl acetate.

FIG. 3 shows a plot of abundance of gas phase protonated monomer hydrates of protonated monomers with time after a binary mixture is introduced into a gas ion distillation device. Ions were extracted from the reactive volume and mass analyzed with selected ion monitoring and a quadrupole mass spectrometer. The formation of ions for chemical constituent 192, 2,6-di-t-butyl pyridine, leads the ion yield against chemical constituent 131, pentyl acetate. The separation of constituents 192 and 131 seen arise from large differences in reaction rate coefficients of ionization.

In contrast, when the chemical constituents of the sample had comparable ionization properties, the constituents being pentyl acetate 131 and hexyl acetate 159, the formation of ions was similar with only a slight difference in both rate or timing for ion formation, as shown in FIG. 4 showing gas ion distillation of ions from two compounds of nearly identical chemical properties, i.e. chemical constituent 131, pentyl acetate, and chemical constituent 159, heptyl acetate. Discernible differences in slopes of response for ion totals tell of a ratio of rate coefficients.

In both instances the formation of hydrates of monomer and proton bound dimers, with acetates, necessitate additional processing of findings to provide a detailed quantitative measure of prefractionation. However, the essentials of chemical separation by ionization chemistry are not substantially affected by the additional reactions. Moreover, such cluster ions can be suppressed when hydrated protons are given as the excess reagent rather than the limiting reagent in these proof-of-concept measurements.

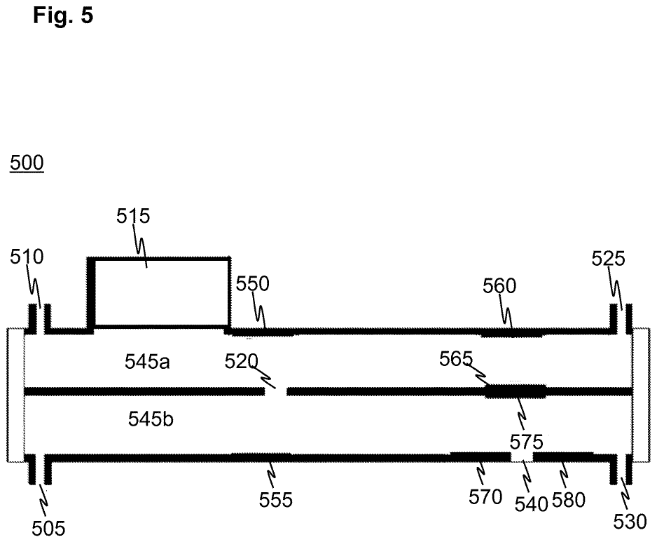

FIG. 5 shows a schematic view of a gas ion distillation apparatus 500 according to an example embodiment. The apparatus 500 comprises a reaction space. the reaction space is at or near ambient pressure. In the embodiment of FIG. 5, the reaction space comprises a first chamber, or a reactant chamber 545a and a second chamber, or sample chamber 545b. The apparatus 500 comprises means 505 for introducing a gaseous sample into the reaction space, a sample inlet, and means 510 for introducing a gaseous reactant into the reaction space, a reactant inlet. In the embodiment of FIG. 5, the apparatus comprises means 515 for producing reactant ions, i.e. means for ionizing the gaseous reactant. In an embodiment, the apparatus 500 comprises a conventional means for ionizing the gaseous reactant, such as radioactive sources, non-radioactive electron sources, UV sources or lasers.

The apparatus further comprises ion transportation means 550-580 for controlling the movement of ions inside the reaction space. In an embodiment, the ion transportation means comprise electrodes for creating an electric field.

The reaction space of the apparatus 500 comprises a channel 520 between the reactant chamber 545a and the sample chamber 545b. Ion transport means 550 and 555 are configured to be activated for transporting reactant ions from the reactant chamber 545a via the channel 520 into the sample chamber 545b in a controlled manner. The reactant ions are then allowed to react with a chemical constituent of the sample as hereinbefore described thus forming product ions.

The apparatus 500 further comprises a reactant outlet 525 and a sample outlet 530. In an embodiment, a constant flow of sample gas from the sample inlet 505 to the sample outlet 530 and a constant flow of gaseous reactant from the reactant inlet 510 to the reactant outlet 525 is maintained.

The product ions formed are transported using the ion transport means and the sample flow towards ion outlet 540. In an embodiment, the ion outlet is configured to be connected to an analyzer, such as to a sample interface of a mass spectrometer or an ion mobility spectrometer. As the formation of the product ions take place selectively according to the gas ion distillation, the chemical constituents of the sample are separately removed from the product ion outlet.

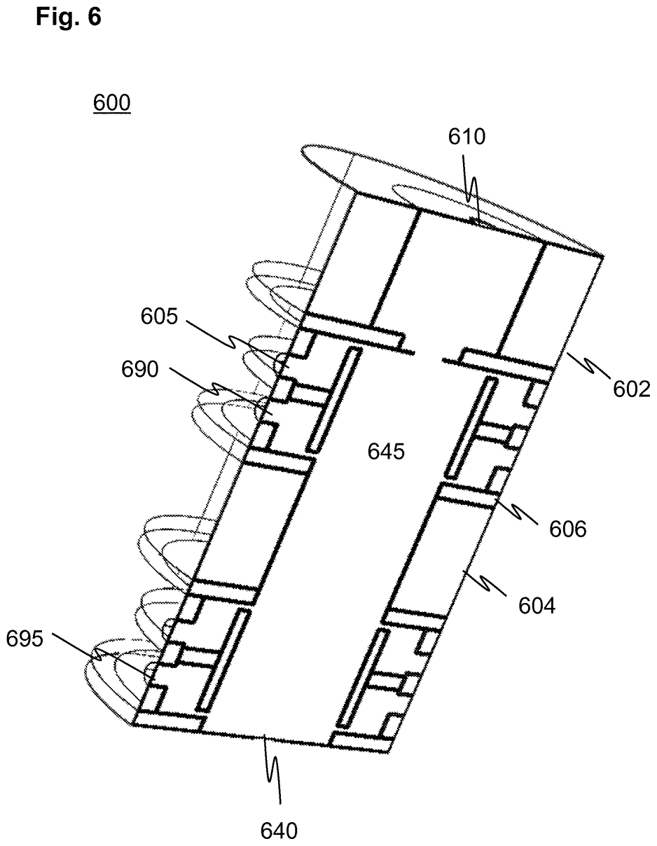

FIG. 6 shows a schematic three-dimensional sectional view of a gas ion distillation apparatus 600 according to an example embodiment. The apparatus 600 comprises a cylindrical frame 602 forming a reaction space 645 therein. The reaction space 645 is held at or near ambient pressure. In an embodiment, the diameter of the cylindrical frame 602 and therethrough the diameter of the reaction space 645 remains substantially the same for the length of the frame. In a further embodiment, the diameter of the cylindrical frame and/or of the reaction space changes. In an example embodiment, the frame and/or the reaction space has a conical, funnel-like or bottle-like form.

The cylindrical frame 602 is in an embodiment formed of a plurality of metal elements 604 with insulation elements 606 therebetween. In an embodiment, the insulation elements 606 comprise polyether ether ketone, PEEK, insulators. In a further embodiment, the insulation elements 606 comprise a further insulating material such as Macor, Teflon or a ceramic insulator.

The apparatus 600 comprises means 610 for introducing a gaseous reactant into the reaction space 645, i.e. a reactant inlet. In an embodiment, the gaseous reactant comprises reactant ions previously produced in a conventional manner, for example using a corona discharge ionizer, radioactive sources, non-radioactive electron sources, X-ray sources, UV sources or lasers. The apparatus further comprises means 605 for introducing a gaseous sample into the reaction space 645, i.e. a sample inlet. In an embodiment, the means 605 for introducing the gaseous sample are configured in such a way that the sample gas is conducted to the end of the reaction space through which the flow of reactant ions enters the reaction space.

The reactant ions and the chemical constituents of the sample are allowed to react in the reaction space as hereinbefore described and product ions are formed selectively from the chemical constituents of the sample according to the gas ion distillation method of the invention. The apparatus 600 comprises an ion outlet 640 through which the product ions are removed from the reaction space 645. The ions are transported to the ion outlet by ion transport means not shown in FIG. 6. In an embodiment, the ion transport means comprise a voltage divider configured to establish an electric field for the length of the reaction space.

The apparatus 600 further comprises buffer gas flow ports 690, 695 configured to provide a flow of buffer gas into the reaction chamber. In an embodiment, the buffer gas flow comprises clean neutral gas. In an embodiment, the buffer gas flow ports are configured to provide the flow into the reaction space from substantially all sides of the reaction space in a circular pattern. The buffer gas flow is configured to provide for a small pressure difference for trapping the gaseous sample to the end of the reaction space for ionization reactions.

In an embodiment, the ion outlet 640 is connected to an analyzer, such as sample interface of a mass spectrometer or an ion mobility spectrometer with which the product ions are analyzed. In an embodiment, the buffer gas flow is configured to provide a gas flow to the analyzer.

FIG. 7 shows a schematic view of an apparatus 700 according to an example embodiment of the invention. The apparatus 700 comprises an apparatus for gas ion distillation integrated with an ion mobility spectrometer.

In ion mobility spectrometry (IMS), ions are separated and characterized based on their motion through a neutral gas under the influence of an electric field. Obviously, only substances that can be ionized are available for analysis, which can be a major drawback of IMS due to the complex and often competing chemical ionization reactions. Especially, already ionized molecules may lose their charge again to neutral molecules of another substance that is “easier” to ionize. Therefore, in complex mixtures just often only the substances that are “easiest” to ionize can be measured. This is one of the major drawbacks of IMS, but can also be used to achieve an additional dimension of separation and/or characterization by ionizability using gas ion distillation.

The apparatus 700 comprises a reaction space 750 in which the ionization reactions according to the method of an embodiment of the invention take place. Further, the apparatus comprises a sample and reactant inlet 710 for introducing a gaseous sample comprising at least two chemical constituents into the reaction space at or near ambient pressure and for introducing a gaseous reagent into the reaction space, and a sample and reactant outlet 715. In an embodiment, the sample and reagent inlet 710 and outlet 715 are connected to a valve arrangement, for example to a four-port valve as shown in FIG. 7 or to a multiport valve with a sample loop.

The apparatus 700 further comprises an ion detector 740 of a type conventionally used in ion mobility spectrometry and ion shutters 730, 732 and 734 configured to be establish an electric field in order to transport ions onward. Hereto it is noted that although three ion shutters are shown in FIG. 7, the number thereof is not limited thereto. The apparatus further comprises an inlet 725 and an outlet 720 for providing a flow of buffer, or neutral gas, into the reaction space.

FIG. 7 shows the apparatus 700 in operation depicted from top to bottom using temporal separation. In a first stage, gaseous sample and reagent flow is introduced into the reaction space via the sample and reagent inlet 710 and outlet 715 via using the four-port valve 705. Chemical constituents A, B and C are present in the sample flow. The reactant ions are either provided already ionized or ionization means are used in the reaction space 750 to ionize the gaseous reactant. In an embodiment, the ionization means comprise conventional solutions, such as for example radioactive sources, non-radioactive electron sources, X-ray sources, UV sources or lasers. Ionization of the chemical constituents A, B and C selectively takes place according to gas ion distillation according to the invention as hereinbefore described.

At stage two, the sample and reactant flow is stopped, or significantly reduced, and ion shutters 730-734 are operated to transport the ions towards the ion detector 740. As the ionization reactions of the chemical constituents take place selectively, the chemical constituents are ionized in the order of their ionizability and in FIG. 7 the chemical constituent A is first transported and removed from the reaction region and transported towards the ion detector 740, followed by chemical constituent B. The stage two is continued until all constituents have been ionized and transported to the ion detector and the ion detector 740 detects only the spectra of the reactant ions.

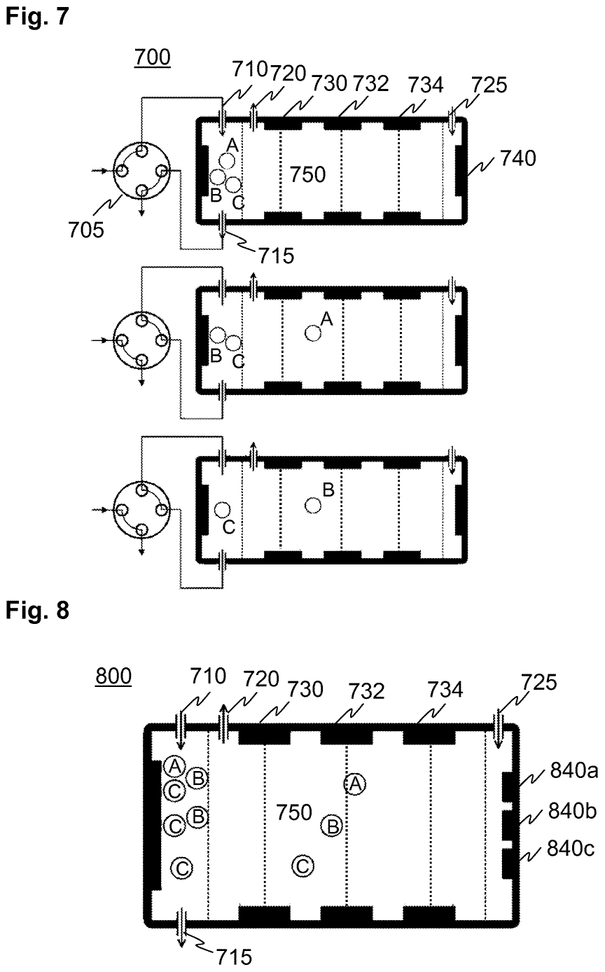

FIG. 8 shows a schematic view of an apparatus according to an example embodiment of the invention. FIG. 8 shows an embodiment of the apparatus of FIG. 7 used for spatial separation using gas ion distillation. The apparatus of 800 of FIG. 8 comprises the elements discussed with reference to FIG. 7.

The apparatus 800 comprises means 710, i.e. a sample and reactant inlet, for introducing a gaseous sample and reactant flow into the reaction space 750 at or near ambient pressure and sample and reactant outlet 715. In operation, a sample and reactant flow is established between the sample and reactant inlet 710 and outlet 715. The reactant ions are either provided already ionized or an ionization means are used in the reaction space 750 to ionize the gaseous reactant. In an embodiment, the ionization means comprise conventional solutions, such as for example radioactive sources, non-radioactive electron sources, X-ray sources, UV sources or lasers. Ionization of the chemical constituents A, B and C selectively takes place according to gas ion distillation according to the invention as hereinbefore described.

The amount of flow from the inlet 710 to the outlet 715 is chosen to be low enough to allow a spatial change in the concentration of chemical constituents A, B and C and their product ions along the flow direction. In a further embodiment, the sample gas flow rate is chosen so that all substances of interest have been extracted exactly at the end of the reaction region. If the flow is higher, the separation is incomplete and not all substances are measured, if the flow is lower, the full possible separation range is not used as no substance can reach the lower segments. If a segmented detector is used, this can be confirmed by adjusting the sample gas flow so that the last detector segment in sample gas flow direction measures only reactant ions, but the second to last detector segment still measures sample ions. In an embodiment, the flow rate is adjusted during operation, for example when the sample concentration changes. The flow rate is chosen in accordance with the geometry and design of the apparatus.

The ion detector of the apparatus 800 is segmented into separate regions 840a-c so that the product ions of the chemical constituent with the highest ionizability strike the detector 840a and so on. While three detector segments 840a-c have been depicted, the number is in further embodiment different therefrom. In a further embodiment, instead or in addition to separate ion detector segments 840a-c, means for establishing deflecting electric fields into the reaction space 750 are provide in order to guide product ions from only certain portion of the reaction space towards the ion detector.

In a further embodiment, one or more known chemical constituents are added by suitable introduction means into the gaseous sample so that they function as standards in order to aid identification of the chemical constituents, as gas ion distillation measures ionizability only on a relative scale.

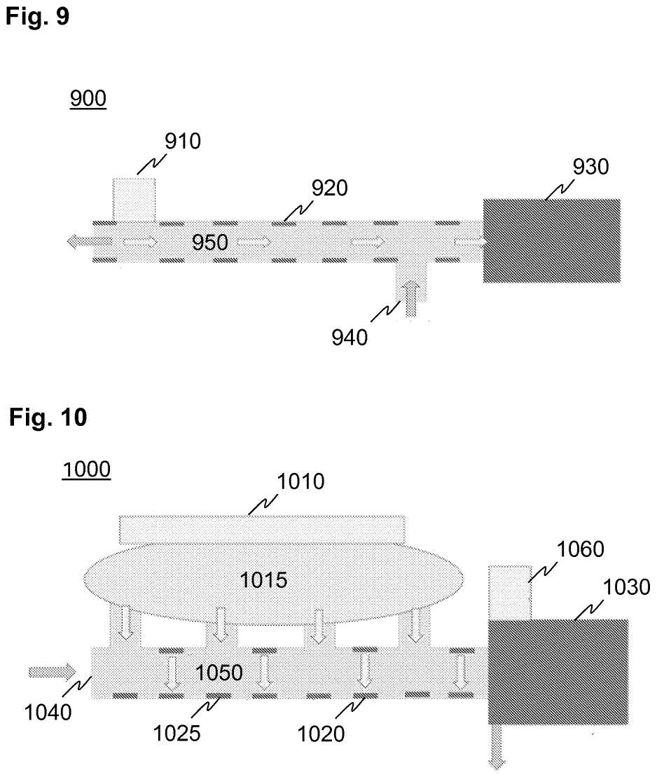

FIG. 9 shows a schematic view of an apparatus 900 according to an example embodiment of the invention. The apparatus 900 comprises an apparatus for gas ion distillation combined with an ion detector 930, for example an ion mobility spectrometer or a mass spectrometer.

The apparatus 900 comprises a reaction space 950 at or near ambient pressure and a sample inlet 940 through which a gaseous sample with at least two chemical constituents is introduced into the reaction space 950. In an embodiment, a drift gas, i.e. an inert gas, is introduced together with the sample through the sample inlet 940. In an embodiment, the gaseous sample is introduced as gas pulses. The flow of sample gas is established into the reaction space 950 from right to left in the figure shown by darker arrows.

The apparatus 900 further comprises means for introducing reactant ions into the reaction space 950. Alternatively, in an embodiment a reactant gas is introduced into the reaction space and the reactant is ionized therein as also described hereinbefore. The apparatus 900 further comprises a plurality of transport means 920, in an embodiment electrode pairs, for establishing an electric field for transporting the reactant ions and product ions formed towards the ion detector 930 in the direction of the lighter arrows in the figure.

In operation, according to the gas ion distillation method according to the invention, the reactant ions will selectively ionize the chemical constituents of the sample, i.e. the reactant ions will first ionize the chemical constituents with the highest reaction rate constants and the product ions thus formed will begin to be transferred towards the ion detector 930.

Chemical constituents with lower reaction rate constants will be ionized later, therefore once they have already moved with the sample flow closer to the ion source or outlet of the reaction space. The chemical constituents of the sample introduced will therefore be separated by gas ion distillation and the ions will arrive at different times to the ion detector.

FIG. 10 shows a schematic view of an apparatus 1000 according to an example embodiment of the invention. The apparatus 1000 comprises an apparatus for gas ion distillation combined with an ion detector 1030, for example an ion mobility spectrometer or a mass spectrometer.

The apparatus 1000 comprises a reaction space 1050 at or near ambient pressure and a sample inlet 1040 through which a gaseous sample with at least two chemical constituents is introduced into the reaction space 1050. In an embodiment, a drift gas, i.e. an inert gas, is introduced together with the sample through the sample inlet 1040. The flow of sample gas is established into the reaction space 1050 from left to right in the figure shown by darker arrows.

The apparatus 1000 further comprises means for introducing reactant ions into the reaction space 1050. Means for introducing reactant ions comprise an ion source 1010 of a type discussed hereinbefore, a reactant ion reservoir 1015 and at least one reactant electrode or several reactant electrodes 1025 configured to be operated to pull reactant ions from the reactant reservoir 1015 into the reaction space 1050. Alternatively, in an embodiment, a reactant gas is introduced into the reaction space and the reactant is ionized therein as also described hereinbefore.

The apparatus 1000 further comprises at least one separation means or several separation means 1020, in an embodiment electrode pairs, for establishing an electric field for removing product ions formed in gas ion distillation therebetween. The apparatus 1000, in an embodiment, further comprises an optional second reactant ion source 1060, for introducing reactant ions into the end of the reaction space 1050 or at the ion detector for reactions with the chemical constituents that have not yet been ionized.

In operation, according to the gas ion distillation method according to the invention, the reactant ions will selectively ionize the chemical constituents of the sample, i.e. the reactant ions will first ionize the chemical constituents with the highest reaction rate constants and the product ions thus formed will be removed at the first separation means 1025, the chemical constituents with the next highest reaction rate constants will be removed at the next separation means 1020 and so on. Hence, the chemical constituents will be filtered from the sample flow one by one and subsequently, in an embodiment, are then transported to the detector one by one.

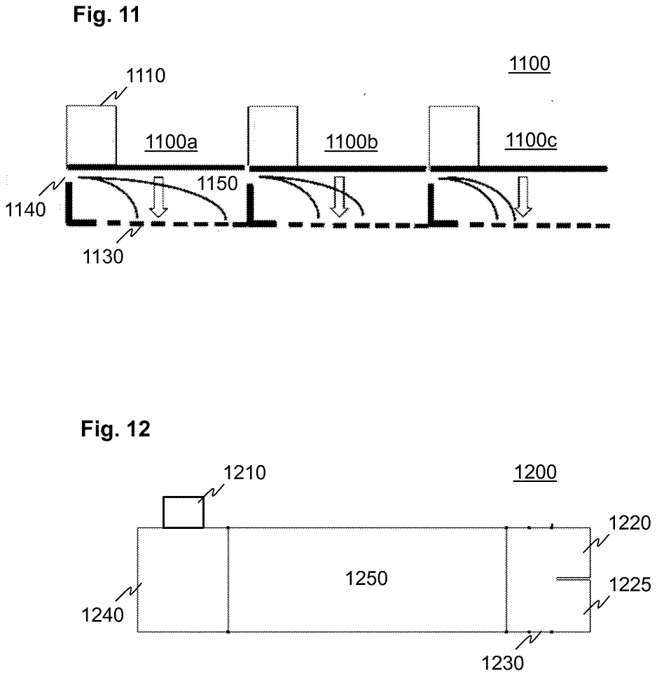

FIG. 11 shows a schematic view of an apparatus 1100 according to an example embodiment of the invention. The apparatus 1100 comprises several modules 1100a-c using gas ion distillation in series. In the embodiment of FIG. 11, three gas ion distillation modules with aspirating ion mobility spectrometry are connected in series, but the number of modules is in an embodiment much higher. In an embodiment, the ions are detected by different faraday cups or other detection systems as mentioned hereinbefore.

Each module 1100a-c of the apparatus 1100 comprises similar elements. Each module comprises a reaction space 1150 at or near ambient pressure and a sample inlet 1140 through which a gaseous sample with at least two chemical constituents is introduced into the reaction space 1150. In an embodiment, a drift gas, i.e. an inert gas, is introduced together with the sample through the sample inlet 1140. The flow of sample gas is established into the reaction space 1150 from left to right in the figure.

Each module further comprises means 1110 for introducing reactant ions into the reaction space 1150. Alternatively, in an embodiment a reactant gas is introduced into the reaction space and the reactant is ionized therein as also described hereinbefore. Each module further comprises an ion detector array 1130 towards which ions formed are pulled by an electric field in the direction of the arrows in the figure.

In operation, according to the gas ion distillation method according to the invention, the reactant ions will selectively ionize the chemical constituents of the sample, i.e. the reactant ions will first ionize the chemical constituents with the highest affinities and the product ions thus formed are pulled towards the ion detector 1130. Only the chemical constituents having the highest affinity are ionized in the first module and further chemical constituents are conveyed with the flow to the following modules in which they are selectively ionized according to the gas ion distillation method according to the invention.

In a further, not depicted, embodiment, trapped ion mobility spectrometry (TIMS) is applied, wherein ions are held stationary in a flowing buffer gas by an equilibrium of forces resulting from the gas flow and an axial electric field gradient. The substances are applied in a short injection time. In such an embodiment, reactant ions are injected continuously into the buffer gas in order to ionize the chemical constituents selectively according to the gas ion distillation method of the invention. The first chemical constituent is trapped in a position resulting from the equilibrium between the electric field, with the field strength dependent of the position and the drag force of the buffer gas. The second chemical is ionized later and will be trapped on another position due to its different mobility. After the ionized chemical constituents are trapped, the electric fields can be controlled in such a way as to convey the trapped ions to the ion detector one by one.

FIG. 12 shows a schematic view of an apparatus 1200 according to an example embodiment of the invention. The apparatus 1200 comprises an apparatus for gas ion distillation for purification of air, i.e. for removal of contaminants from air. The apparatus 1200 comprises an air inlet 1240 through which air to be purified, for example from volatile organic compounds, is brought into the apparatus 1200. The apparatus 1200 further comprises means 1210 for introducing reactant ions into a reaction space 1250. Alternatively, in an embodiment a reactant gas is introduced into the reaction space and the reactant is ionized therein as also described hereinbefore.

The apparatus 1200 further comprises a clean air outlet 1220 and a contaminant outlet 1225 through which, respectively, clean air and any contaminants separated by gas ion distillation from the inlet air are removed. The apparatus 1200 further comprises separation means 1230, in an embodiment an electrode pairs, for establishing an electric field for removing product ions formed in gas ion distillation according to the invention, i.e. transporting the product ions of the contaminants to the contaminant outlet 1225.

Various example embodiments of the invention have been explained hereinbefore. It should be noted that the methods and apparatuses described comprise in embodiments steps, parts or elements not described hereinbefore but apparent to a skilled person. For example, the means and equipment for establishing an electric field or using a pump in order to establish a gas flow are commonly practiced by a skilled person and need not be described in detail.

The same applies to combinations of separation technologies, such as for example gas chromatography (GC) and gas ion distillation which could for example help to identify coeluting peaks from GC.

Some use cases of the gas ion distillation method and apparatus according to embodiments of the present invention are presented in the following. In a first use case gas ion distillation according to an embodiment of the invention is used by first responders for pre-fractionating a sample prior to using for example ion mobility spectrometry for explosives detection.

In a second use case gas ion distillation according to an embodiment of the invention is used by first military personnel or the like for pre-fractionating a sample prior to using for example ion mobility spectrometry for detection of chemical weapons or traces thereof.

In a third use case gas ion distillation according to an embodiment of the invention is used by medical personnel in analysis of the breath of a person.

In a fourth use case gas ion distillation according to an embodiment of the invention is used in inspecting food contamination.

In a fifth use case gas ion distillation according to an embodiment of the invention is used in industrial production to separate chemicals.

In a sixth use case gas ion distillation according to an embodiment of the invention is used to purify or filter ambient air.

Any of the afore described methods, method steps, or combinations thereof, may be controlled or performed using hardware; software; firmware; or any combination thereof.

The software and/or hardware may be local; distributed; centralized; virtualized; or any combination thereof. In an embodiment, any of the afore described methods, method steps, or combinations thereof, may be controlled or performed using a remote server and/or a cloud-based service. Moreover, any form of computing, including computational intelligence, may be used for controlling or performing any of the afore described methods, method steps, or combinations thereof. Computational intelligence may refer to, for example, any of artificial intelligence; neural networks; fuzzy logics; machine learning; genetic algorithms; evolutionary computation; or any combination thereof.

Without in any way limiting the scope of the appended claims, some technical effects of the example embodiments of the invention are explained in the following.

The method and apparatus according to example embodiments of the invention shown in FIGS. 1-12 is configured to provide for an improved separation of chemical constituents of a sample. The method according to example embodiments of the invention is further configured to provide a method of chemical separation that is easy and cost-effective and energy saving. Furthermore, according to example embodiments of the invention, the chemical separation can be carried out in ambient pressure. Moreover, the example embodiments of the invention provide for a chemical separation that is scalable to different capacities from portable apparatus to large industrial applications and scalable to various conditions.

Various embodiments have been presented. It should be appreciated that in this document, words comprise; include; and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A method of separating chemical constituents by gas ion distillation, comprising introducing a gaseous sample into a reaction space at a pressure above about 10 torr, wherein the gaseous sample comprises at least two chemical constituents;
introducing a gaseous reactant into the reaction space, wherein the reactant comprises reactant ions configured to selectively ionize the at least two chemical constituents of the sample;
allowing the reactant ions to selectively ionize the at least two chemical constituents of the sample to form product ions, wherein the order of product ion formation is governed by the vapour concentrations of the at least two chemical constituents, the concentration of the reactant ions and the reaction rate coefficients of the at least two chemical constituents; and
subsequently removing the ionized at least two constituents from the reaction space in the order of product ion formation.

2. The method of claim 1, wherein the reaction space is at or near ambient pressure.

3. The method of claim 1, further comprising providing a flow of neutral gas into the reaction space in order to retain the gaseous sample in the reaction space.

4. The method of claim 1, wherein removing the ionized at least two constituents from the reaction space comprises conveying using electric fields.

5. The method of claim 1, wherein the reactant ions comprise positive ions selected from the group of hydrated protons H⁺(H₂O)ₙ, ammonia ions (H₂O)ₙNH₄⁺ and acetone ions such as (CH₃COCH₃)₂H⁺.

6. The method of claim 1, wherein the reactant ions comprise negative ions selected from the group of hydrated oxygen ions O₂⁻(H₂O)ₙ and halogenated ions such as chloride or bromide ions.

7. The method of claim 1, wherein the ionization of a chemical constituent is governed by the vapour concentration of the constituent, the concentration of the positive reactant ions, and the reaction rate coefficients k₁ and k₂ of the chemical constituents with the equation of
$$\frac{d [ {R}^{+} ]}{dt} = - {k}_{1} [ M ] [ {R}^{+} ] - {k}_{2} [ N ] [ {R}^{+} ] .$$

8. The method of claim 7, wherein the ionization of a chemical constituent is governed by the vapour concentration of the constituent, the concentration of the negative reactant ions with a similar equation.

9. The method of claim 1, wherein removing the ionized at least two constituents from the reaction space comprises conveying them to an analysis.

10. The method of claim 1, wherein removing the ionized at least two constituents from the reaction space comprises temporarily trapping them into the reaction space.

11. The method of claim 9, wherein the analysis comprises an analysis with an ion mobility spectrometer, a mass spectrometer or a further spectroscopic or electrochemical analytical instrument.

12. The method of claim 1, wherein introducing a gaseous reactant comprising reactant ions into the reaction space comprises introducing a gaseous reactant into the reactant space and generating the reactant ions therein.

13. The method of claim 1, wherein the reactant ions are generated by ionization using radioactive sources, non-radioactive sources such as electron sources, electrical discharge sources such as corona or barrier discharge, X-ray sources, UV sources and/or lasers.

14. An apparatus for separating chemical constituents by gas ion distillation, comprising a reaction space;
means for introducing a gaseous sample into the reaction space at a pressure above about 10 torr, wherein the gaseous sample comprises at least two chemical constituents;
means for introducing a gaseous reactant into the reaction space, wherein the reactant comprises reactant ions configured to selectively ionize the at least two chemical constituents of the sample;
means for removing the ionized at least two constituents from the reaction space in the order of product ion formation, wherein the at least two chemical constituents have been ionized in the reaction space by allowing the reactant ions to selectively ionize the at least two chemical constituents of the sample to form product ions, wherein the order of product ion formation is governed by the vapour concentrations of the at least two chemical constituents, the concentration of the reactant ions and the reaction rate coefficients of the at least two chemical constituents.

15. The apparatus of claim 14, wherein the reaction space is at or near ambient pressure.

16. The apparatus of claim 14, further comprising an analyzer, and an ion outlet for removing ions from the reaction space and configured to be attached to an analyzer, wherein the analyzer comprises an ion mobility spectrometer or a mass spectrometer or a further spectroscopic or electrochemical analytical instrument.

17. (canceled)

18. The apparatus of claim 14, wherein the means for removing the ionized at least two constituents from the reaction space comprise an arrangement for generating electric fields for transporting the ionized at least two constituents.

19. The apparatus of claim 14, wherein the means for removing the ionized at least two constituents from the reaction space comprise an arrangement for generating electric fields temporarily trapping the ionized at least two constituents.

20. The apparatus of claim 14, wherein the means for removing the ionized at least two constituents from the reaction space comprise an arrangement for removing the ionized at least two constituents temporally or spatially separated.

21. The apparatus of claim 14, further comprising a cylindrical frame defining the reaction space therein, wherein the reaction space is cylindrical.
